(19) United States
(12) Patent Application Publication
(10) Pub. No.: US 2015/0287084 A1
(43) Pub. Date: Oct. 8, 2015

(54) SYSTEMS AND METHODS FOR IMPLEMENTING ONLINE MARKETPLACE FOR LOCAL MERCHANTS

(71) Applicant: EBAY INC., San Jose, CA (US)

(72) Inventors: Ron Gura, Tel Aviv (IL); Matanya Bar, Tel Aviv (IL); Erez Dickman, Tel Aviv (IL)

(21) Appl. No.: 14/243,763

(22) Filed: Apr. 2, 2014

(51) Int. Cl. G06Q 30/02; G06Q 30/06

(52) U.S. Cl. CPC G06Q 30/0261; G06Q 30/0633

(57) ABSTRACT

A system or method for implementing an online marketplace for local merchants is provided. In particular, an online portal or interface is provided to allow local merchants to set up virtual stores at the online marketplace. The portal or interface may be configured to register a local merchant by receiving and storing the local merchant's information. For example, the local merchant may enter the merchant's name, type of merchant, operating hours, location, directions, type of products or services offered, delivery service, delivery range, wait time, inventory status, and the like. In particular, a database may be provided at the online marketplace to receive the local merchant's product information. The local merchant may upload product/inventory list, price list, product information, availability status, product condition, or the like to the database of the online marketplace.

### BACKGROUND

1. Field of the Invention

The invention relates generally to systems and methods for implementing an online marketplace for local merchants.

2. Related Art

With the proliferation of internet commerce, consumers increasingly make purchases from online merchants. Most online purchases require mailing or shipping to customers. Nevertheless, certain products or services are not suitable for mailing or shipping, such as dairy products or fresh produce. Moreover, the process of shipping and mailing also is not deemed environmentally friendly, because it may add to the carbon footprint of the purchased products. As such, it may be more environmentally friendly and more convenient to purchase certain products or services from local merchants. Further, consumers are making more purchases from large online merchants at the detriment of local small and/or medium businesses (SMB). Local SMB's, such as local grocery stores, typically do not have online stores and are not accessible online via the internet. Thus, even if consumers wish to purchase from SMB's, it is more difficult for consumers to find or locate local SMB's near them and it is more difficult for local SMB's to compete with large online merchants. Therefore, there is a need for systems and methods that implement an online marketplace for local SMB.

### BRIEF DESCRIPTION OF THE FIGURES

FIG. 1 is a block diagram of a networked system suitable for implementing an online marketplace for local merchants according to an embodiment.

FIG. 2 is a flowchart illustrating a method for setting up an online marketplace for a local merchant according to an embodiment.

FIG. 3 is a flowchart illustrating a method for making purchases from local merchants at an online marketplace according to an embodiment.

FIG. 4 is a block diagram of a computer system suitable for implementing one or more components in FIG. 1 according to one embodiment of the present disclosure.

Embodiments of the present disclosure and their advantages are best understood by referring to the detailed description that follows. It should be appreciated that like reference numbers are used to identify like elements illustrated in one or more of the figures, wherein showings therein are for purposes of illustrating embodiments of the present disclosure and not for purposes of limiting the same.

### DETAILED DESCRIPTION

In one embodiment, a system or method for implementing an online marketplace for local SMB's, such as local grocery stores, is provided. In particular, an online portal or interface is provided to allow local merchants, such as local grocery stores, to set up virtual stores at the online marketplace. The portal or interface may be configured to register a local merchant by receiving and storing the local merchant's information. For example, the local merchant may enter the merchant's name, type of merchant, operating hours, location, directions, type of products or services offered, delivery service, delivery range, wait time, inventory status, and the like. In particular, a database may be provided at the online marketplace to receive the local merchant's product information. For example, the local merchant may upload product/inventory list, price list, product information, availability status, product condition, or the like to the database of the online marketplace. In another example, the local merchant may post real-time notifications or advertisements at the online marketplace to entice local customers to visit or make purchase at the local merchant.

In an embodiment, a local merchant shopping application may be provided to allow local customers to search for local merchants, e.g., local SMB's. For example, a customer may search for local grocery stores located within 5 miles from the customer that offer certain product or service. Further, the local merchant shopping application may allow customers to browse and purchase products or services from local merchants located near customers. Customers may choose to pick up the purchased products or may request that the purchased products be delivered to them. Customers may provide additional or specific information regarding the purchase. For example, customers may request that the products be ready for pick up within an hour or that the products be delivered to them within a specific time window. As such, the system enables the customers to find SMB's located near them, such as local grocery stores or shops. Further, the system allows SMB's to provide personalized service or delivery to local customers. Thus, the system enables customers to be heroes of their community by purchasing from local SMB's in their community.

In another embodiment, the shopping application may allow real-time communication, such as text messaging, email, or phone call, between local merchants and customers. For example, customers may inquire information regarding the local merchant or the products or services of the local merchant. The local merchant may respond in real time to the customer's inquiries. In another example, customers may provide specific instructions for various products or services and the local merchant may respond and provide specific services based on these specific instructions. In a further example, the local merchant may notify the customer when a particular item of interest is available or will be available, based on knowledge of the customer's preferences.

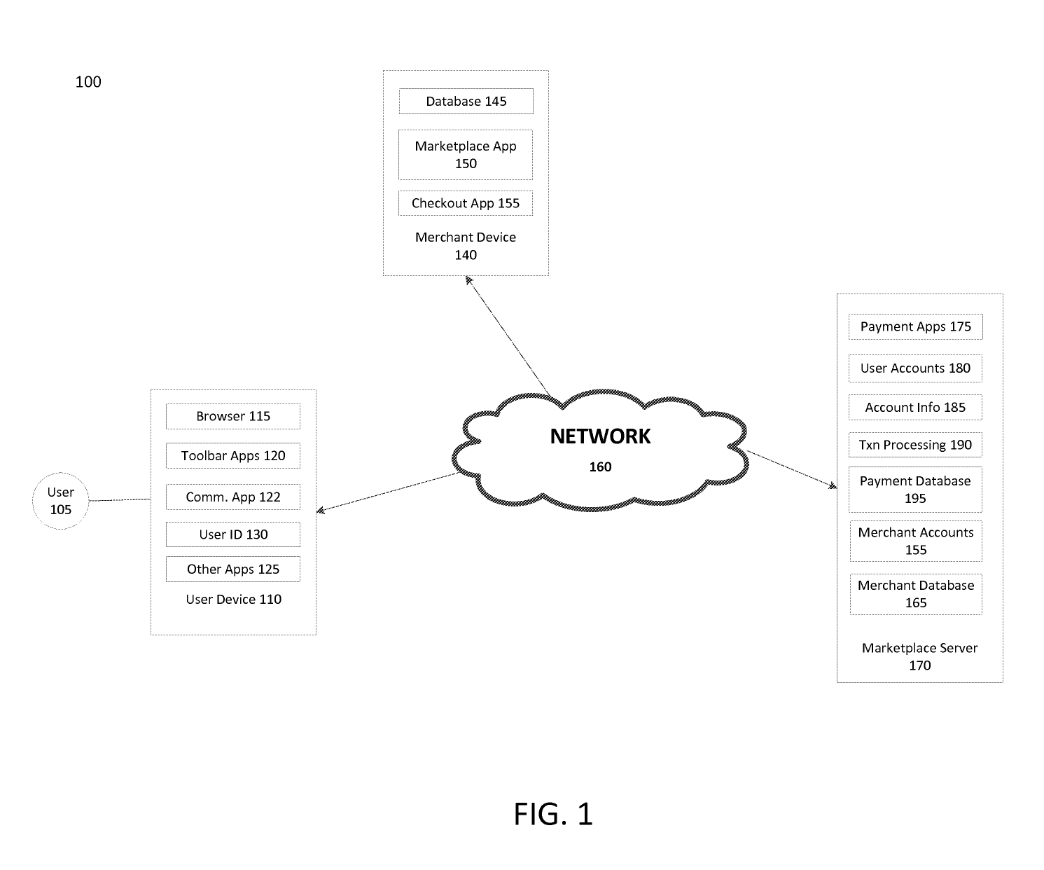

FIG. 1 is a block diagram of a networked system 100 suitable for implementing working capital for merchants according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant device 140, and a marketplace server 170 in communication over a network 160. Marketplace server 170 may be maintained by a marketplace service provider, such as eBay, Inc. of San Jose, Calif. A user 105, such as a sender or consumer, utilizes user device 110 to browse and shop for various products or services using marketplace server 170. User 105 may utilize user device 110 to browse, shop, make purchase, and/or implement a payment transaction. Note that transaction, as used herein, refers to any suitable action performed using the user device, including payments, transfer of information, display of information, etc. For example, user 105 may utilize user device 110 to initiate a deposit into a savings account. Although only one user device is shown, a plurality of user devices may utilize the payment service provider to make purchase at the merchant.

User device 110, merchant device 140, and marketplace server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, user device 110 may be implemented as a personal computer (PC), a smart phone, laptop computer, wearable computing device, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for setting up a shopping list and/or merchant sites for viewing and purchasing products and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications.

Applications 125 may also include email, texting, voice and IM applications that allow user 105 to send and receive emails, calls, and texts through network 160, as well as applications that enable the user to communicate, transfer information, and/or make purchases/payments at the online marketplace as discussed above. User device 110 includes one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by an online marketplace service provider to associate user 105 with a particular account maintained by the online marketplace. A communications application 122, with associated interfaces, enables user device 110 to communicate within system 100.

Merchant device 140 may be maintained, for example, by a local merchant or seller offering various products and/or services. The local merchant may be a SMB that has a physical point-of-sale (POS) store front. The merchant may have a merchant account with the online marketplace service provider. Merchant device 140 may be used for POS or online purchases and transactions. Generally, merchant device 140 may be maintained by anyone or any entity that receives money, which includes banks and retailers. Merchant device 140 may include similar components as user device 110. Further, merchant device 140 may include a database 145 identifying available products (including digital goods) and/or services (e.g., collectively referred to as items). The database 145 may be uploaded to marketplace server 170 to be made available for viewing and purchase at the online marketplace.

Accordingly, merchant device 140 also may include a marketplace application 150 which may be configured to connect to marketplace server 170. In one embodiment, an owner or operator of a local merchant may interact with marketplace application 150 to upload the local merchant's information to marketplace server 170 over network 160 in order to present various products, food items, or services of the local merchant at the online marketplace. In an embodiment, marketplace server 170 may be linked to merchant device 140 and the information of the local merchant may periodically be pulled from the merchant device 140 to marketplace server 170 to continuously update the local merchant's information, such as product inventory or service status.

Marketplace server 170 may be maintained, for example, by an online marketplace service provider which may provide a marketplace for trade or purchase transactions between consumers and merchants. In this regard, marketplace server 170 includes one or more payment applications 175 which may be configured to interact with user device 110 and/or merchant device 140 over network 160 to facilitate the purchase of goods or services, communicate/display information, and send payments by user 105 of user device 110.

Marketplace server 170 also may maintain a plurality of user accounts 180, each of which may include account information 185 associated with consumers, merchants, and funding sources, such as banks or credit card companies. For example, account information 185 may include private financial information of users of devices such as account numbers, passwords, device identifiers, user names, phone numbers, credit card information, bank information, or other financial information which may be used to facilitate online transactions by user 105. Advantageously, payment application 175 may be configured to interact with merchant device 140 on behalf of user 105 during a transaction with checkout application 155 to track and manage purchases made by users and which and when funding sources are used.

A transaction processing application 190, which may be part of payment application 175 or separate, may be configured to receive information from user device 110 and/or merchant device 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

Marketplace server 170 may create and store merchant accounts 155 for each local merchant registered with marketplace server 170. Merchant accounts 155 may include various information of a local merchant, such as the name of the local merchant, owner information, type of merchant, service/product offered, location, contact information, operating hours, delivery hours, delivery range, and the like. Marketplace server 170 also may include a merchant database 165 configured to store a database of products/services offered at respective local merchants. For example, merchant database 165 may store a list of various products offered at a grocery store. The list may include product information, such as Universal Product Code (UPC), name of product, description, pictures, price, specification, discounts, and the like. Further, the availability and inventory of the product also may be included and continuously updated. For perishable products, the expiration date also may be included to indicate freshness of the product.

In an embodiment, merchant database 165 may allow a local merchant to store customer information of customers. For example, the local merchant may create a customer profile for a local customer who frequently visits and makes purchases at the local merchant or at other merchants (both online and offline) that offer the same or similar items available at the local merchant. The customer profile may include various information of the customer that may help the local merchant to better serve the customer. For example, the customer profile may include the name of the customer, a picture of the customer, address, purchases made, delivery preferences, pickup preferences, product/service preferences, brand preferences, subscriptions, use of coupons or purchases of sale items, when the customer prefers to shop, and the like. For example, a customer may prefer green bananas for Sunday purchases, but riper bananas for mid-week to end of week purchases. Based on the customer profile, the local merchant may provide personalized product/service to a customer. Customers also may subscribe to certain product/service at the local merchant. For example, a customer may subscribe to have a bag of rice delivered to the customer every month.

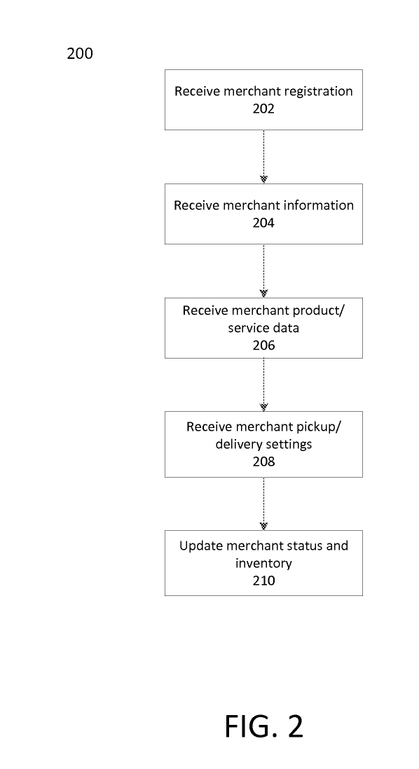

FIG. 2 is a flowchart illustrating a process 200 for setting up an online marketplace for a local merchant according to an embodiment. Process 200 may be executed by marketplace server 170 or a computer or server of an online marketplace service provider. At step 202, marketplace server 170 may receive a local merchant's registration. For example, an owner or operator of a local merchant may use merchant device 140 to register the local merchant at marketplace server 170.

At step 204, marketplace server 170 may receive local merchant's information, which include the merchant's name, types of product/service offered at the local merchant, the location of the merchant, the neighborhood the local merchant is serving, operating hours indicating when customers may visit the local merchant, hours of delivery indicating when product delivery is available, contact information, type of payments accepted, and the like. In particular, marketplace server 170 may provide an online interface to receive various inputs from the local merchant. Further, marketplace server 170 may allow the local merchant to enter or upload pictures, videos, audio recordings, or the like to further customize the local merchant's virtual store at the marketplace server 170. For example, a local merchant may upload colors, trademarks, logos, slogans, or the like to customize the virtual store of the local merchant at the online marketplace.

At step 206, marketplace server 170 may receive product/service data from merchant device 140. For example, marketplace server 170 may provide an interface to receive a list or a table of information related to products/services offered at the local merchant from merchant device 140. The information may include a name of a product/service, price, picture, product/service description, nutritional information, expiration date/time, applicable discount/coupon, eligibility for delivery, and the like. In an embodiment, the produce/service information may be uploaded to marketplace server 170 by the local merchant. In another embodiment, the local merchant may allow marketplace server 170 to access and pull the product information from merchant device 140.

At step 208, marketplace server 170 may receive the local merchant's pickup/delivery settings. In particular, marketplace server 170 may provide an interface at which the local merchant may enter various pickup/delivery settings. For example, the local merchant may set the hours when delivery is available, locations/neighborhoods where the local merchant is able to make delivery, and the type of products eligible for delivery. The local merchant also may indicate how long the delivery process will take, such that the customer may anticipate how long to wait for the delivery. In an embodiment, the local merchant may set a different delivery time for different locations. For example, a further location may require longer delivery time compared to a closer location. The local merchant may also set a fee for the delivery service. In an embodiment, the local merchant may offer free delivery for purchases above a certain amount or for customers enrolled in a loyalty program (or other indication of loyal or repeat customers). Marketplace server 170 also may allow the local merchant to indicate whether customers may purchase online for an in-store pick up. The local merchant may set a pick-up time when the purchased items will be ready for pick up.

In an embodiment, the local merchant may provide a delivery schedule for various neighborhoods. For example, the local merchant may make routine daily delivery to various neighborhoods. The local merchant may make deliveries at neighborhood A between 10:00 AM and 12:00 PM, at neighborhood B between 12:00 PM and 2:00 PM, and at neighborhood C between 2:00 PM and 4:00 PM during week days. Thus, customers at various neighborhoods may estimate when delivery from the local merchants may be made. The local merchant also may make emergency deliveries in addition to the routine delivery for a certain fee. Thus, customers have the option of requesting an emergency delivery for any urgent needs by paying a fee.

In some embodiments, a fee schedule may be provided for deliver to various neighborhoods. For example, different fees may be charged for delivery to different neighborhoods. A neighborhood further from the local merchant may have a higher delivery fee than a neighborhood closer to the local merchant. Further, the local merchant may be allowed to define various delivery zones or neighborhoods where the local merchant makes delivery for various fees. Various fees and services may be dependent on a particular customer. For example, for a new customer who just moved into the neighborhood, the local merchant may offer free delivery for the first month.

In an embodiment, the local merchant may provide services and/or fees that are based on a specific customer. For example, the local merchant's services or fees may be determined based on how long a customer has resided in a neighborhood. Long-time local customers who have been living in the community for years may be offered special deals, as opposed to the customer who is just visiting. New residents may be offered special welcome discounts or services, such as free grocery delivery, for the first month. As such, new residents may be introduced to the local merchant.

In some embodiments, the system may allow a local merchant to establish a pricing scheme based on different types/categories of customers. For example, based on a customer's shopping habit, shopping schedule, location, purchase history, and the like, different discounts or offers may be generated to entice the customer to make a purchase at the local merchant. In an example, a customer may get a free delivery service for every $100 dollars spent at the local merchant. In another example, a customer who frequently purchases a certain product, such as milk, may be asked to subscribe to the product to get a special discount. As such, the local merchant may automatically prepare and/or deliver milk to the customer based on the subscription.

In another example, the local merchant may set the prices for certain products to change over time. For example, the prices of perishable products may gradually decrease over time to entice customers to purchase products that are soon to expire and are ready to be used. The changing prices may be presented at the local merchant's virtual store. In another example, the local merchant may give special discounts to customers residing directly in the local merchant's neighborhood or community. As such, the local merchant may provide strong incentives for customers to shop locally. In still another example, the local merchant may receive recommendations or suggestions from local customers on products or services that customers desire to have but currently are not offered at the local merchant. Thus, the local merchant may be informed of new products/services that may be desired by local customers.

At step 210, marketplace server 170 may receive updates of the local merchant's status and inventory. In particular, the local merchant may indicate its status at the online marketplace, such as whether the store is open or closed, how long the wait is at the checkout line, inventory of products, availability of services. Further, the local merchant may post notifications or advertisements, such as advertisements for newly arrived products, discounts for certain items, freshly arrived produce, and the like. In an embodiment, the local merchant may send the updates or notifications to marketplace server 170 to be posted at the online marketplace. In another embodiment, marketplace server 170 may pull the information from merchant device 140 periodically to update the local merchant's information. Marketplace server 170 may broadcast the local merchant's notifications or advertisements to consumers located in the neighborhood where the local merchant serves. For example, text messages or emails, such as “Freshly arrived fruit today at Abby's market,” may be sent to consumers' mobile devices located in the neighborhood near Abby's market. Notifications may be sent to specific customers based on a specific item that may be of interest to the customer, such as a customer who prefers more ripe bananas. In that case, that customer may not be notified when a new shipment of bananas arrives, but will be notified a few days later when the bananas have ripened.

Accordingly, process 200 allows a local merchant to register and setup a virtual store at the online marketplace implemented by marketplace server 170. In particular, various information of the local merchant may be received by marketplace server 170. Product inventory may be uploaded to marketplace server 170 to be presented to consumers. The local merchant also may indicate local settings, such as the location or neighborhood served, delivery settings, in-store pick up settings, and the like. Various status of the local merchant also may be posted at the online marketplace. Further, the local merchant may post real-time notifications or advertisements at the online marketplace to entice local consumers to make purchase at the local marketplace. Thus, local merchants who do not have an online store may readily set up a virtual store at the online marketplace provided at marketplace server 170.

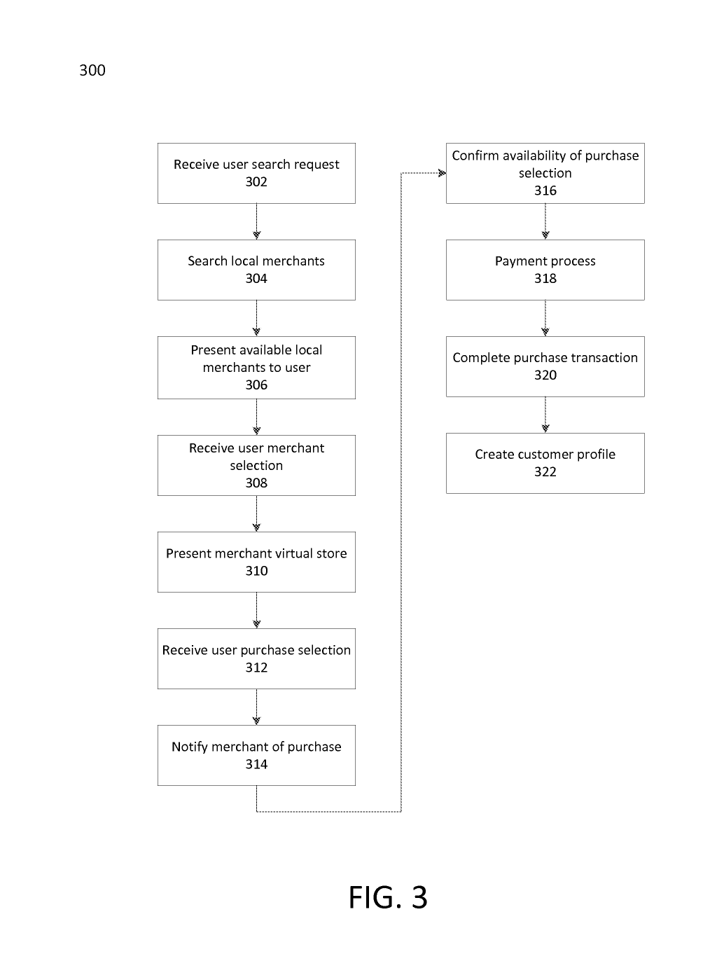

FIG. 3 illustrates a process 300 for making purchases from local merchants at an online marketplace according to an embodiment. At step 302, marketplace server 170 may receive user search request from user device 110. For example, when user 105 desires to make a purchase or find a service from local merchants, user 105 may utilize the shopping app installed on user device 110 to search for a product or a service. User 105 may enter the product or service user 105 is interested in. Marketplace server 170 may also obtain user interest based on other means, such as accessing a user wish/shopping list, past purchases, such as regular recurring purchases, calendar events, such as hosting or attending a party, etc.

At step 304, marketplace server 170 may search for local merchants that offer the product/service or similar product/service. In particular, marketplace server 170 may search for local merchants located near user 105 or local merchants that designate the area of user 105 as a service area. For example, user device 110 may detect a location of user 105 via Global Positioning System (GPS) and may send user 105's location to marketplace server 170. Based on user 105's location, marketplace server 170 may search for local merchants near user 105 or local merchants that service the location of user 105. Further, marketplace server 170 may search for local merchants that offer the desired product or service. Marketplace server 170 also may check whether the local merchants are open and the availability of the desired product or service at the local merchants. In addition, marketplace server 170 may check the delivery or in-store pick up options at the local merchants.

At step 306, marketplace server 170 may present available local merchants to user 105 at user device 110. In particular, a list of local merchants located near user 105 may be presented to user 105. The list of local merchants may include the name of the merchants, the location of the merchants, the availability of the products or services at the merchants, status of the merchants (open or closed), delivery or in-store pickup options at the merchants. Other information, such as coupons/discounts or merchant ratings also may be included with the list, such that user 105 may make informed decisions on which merchant to visit.

At step 308, marketplace server 170 may receive user 105's merchant selection. In particular, user 105 may select a local merchant from the list of local merchants presented at user device 110. User 105's selection may be forwarded to marketplace server 170. At step 310, marketplace server 170 may present the selected local merchant's virtual store to user 105. The virtual store may include the local merchant's front page, trademark, logo, welcoming message, and the like. Further, the availability of the desired product or service at the selected local merchant may be presented to user 105. For example, a picture and/or description of the desired product or service, including price, expiration date, available quantity, and the like may be presented.

In an embodiment, the local merchant's virtual store may include a live chat function by which user 105 may inquire the local merchant via an online chatting function. In another embodiment, a telephone number of the local merchant may be provided such that user 105 may contact the local merchant directly to ask questions regarding the local merchant or produces/services offered at the local merchant. In some embodiments, user 105 may purchase or order products/service via the phone or via the online live chat with the local merchant. Further, user 105 may provide special instructions for the purchase, such as special instructions on how products are to be prepared by the local merchant or how the delivery is to be made to user 105.

At step 312, marketplace server 170 may receive user 105's purchase selection. User 105 may choose to purchase the desired product or service at the local merchant's virtual store. User 105 also may add additional items to the purchase. Further, user 105 may select whether the purchased items should be delivered to user 105 or be prepared for in-store pick up by the user 105. If user 105 selects delivery, user 105 may enter where and when the delivery is to be made. For example, user 105's address may be entered to indicate the delivery address. In an embodiment, the delivery may be made to user 105 based on user 105's GPS location as detected by user device 110.

User 105 may enter special instructions for the purchase, such as how and when the delivery is to be made, e.g., “please deliver between 1:00 PM and 2:00 PM today and place the delivery at the front door.” User 105 also may enter special instructions on how the products are to be prepared. For example, user 105 may designate how the products are to be packaged, such as “please package meat products in a Styrofoam box.” In an embodiment, user 105 may instruct the local merchant on how the products are to be selected, such as “please select only milk with an expiration date later than a week.” These preferences may also be determined from the local merchant without user input based on previously user-set preferences or past instructions by the user for a particular product or purchase.

At step 314, marketplace server 170 may notify the local merchant of user 105's purchase order including any special instructions. The local merchant may confirm that user 105's purchase order may be fulfilled. In particular, the local merchant may check and see if the items requested are available and whether the special instructions may be fulfilled. For example, the local merchant may check and see if the items with appropriate expiration dates are available. Further, the local merchant may confirm whether user 105's requested delivery method or timeframe may be satisfied based on local merchant's schedule.

At step 316, if the local merchant is able to fulfill the purchase order, the local merchant may confirm that the local merchant is ready to fulfill user 105's order. If the local merchant is not able to fulfill the purchase order, the local merchant may respond with reasons why the purchase order cannot be fulfilled. The local merchant also may offer alternatives to user 105's original order. For example, if the local merchant is not able to make delivery within an hour, as requested by user 105, the local merchant may offer to make delivery later for a discounted price or offer to prepare the purchased items for pick up within 15 minutes. The local merchant may also provide a recommendation to another local merchant. The online marketplace interface may provide communication tools for the customer to call, text, or chat with the local merchant in real time to discuss any questions regarding the purchase.

After the local merchant confirms that user 105's purchase order can be fulfilled, marketplace server 170 may initiate a payment process for the purchase at step 318. In particular, user 105 is allowed to select from various payment methods, such as credit cards, debit cards, PayPal, bank accounts, gift cards, and the like. Marketplace server 170 may debit the purchase amount from the customer's payment account or funding source and may credit the purchase amount to the local merchant.

In an embodiment, the local merchant may allow a frequent customer to keep a tab of the purchases made and pay off the tab later. For example, the local merchant may designate certain local customers who are personally known to the local merchant and allowed these local customers to keep tabs and pay later. Marketplace server 170 may keep track of various customers' tabs for the local merchant. In an embodiment, marketplace server 170 may send notifications or summaries to the customers or the local merchant to summarize their tab amount.

At step 320, marketplace server 170 may complete the purchase and payment process and inform the local merchant that the payment process has been completed. The local merchant may begin to prepare the items for delivery or for in-store pickup by the customer based on the purchase request and any special instructions.

At step 322, marketplace server 170 may allow the local merchant to create a customer profile based on the customer's purchases. In particular, the local merchant may set up a customer profile to keep track of a customer's purchase history and/or browsing history. The customer profile may include the customer's name, and/or nickname, picture, address, product/service preferences, special instructions, shopping habits, personal routines, and the like. As such, the local merchant may provide personalized service to each customer based on their customer profiles. For example, user 105 may typically purchase milk every Sunday. Based on user 105's shopping routine, the local merchant may offer to deliver milk to user 105 every Sunday or may prepare milk for user 105 to pick up every Sunday. Thus, user 105 may receive personalized service.

In an embodiment, the local merchant also may generate personalized notifications or advertisements based on the customer profiles. For example, based on the customer's purchase history, advertisements for specific products/services may be sent to targeted customers. If user 105 routinely buys apples at the local merchant, the local merchant may send a notification to user 105 to notify that a fresh shipment of apples just arrived this morning or if new discount price is available for apples at the local merchant. Marketplace server 170 also may provide an interface for customers to review and rate various local merchants. Thus, customers may provide comments regarding the local merchants and good local merchants may be identified and rewarded with more business.

In an embodiment, a reward program may be implemented by the system to reward customers who frequently purchase from local SMB's. For example, for each dollar spent on local grocery stores owned or operated by local owners, such as owners who reside within 10 miles from the customer, the customer may be given a reward point. The customer may be rewarded with extra discounts or certain prizes when a certain amount of reward points are collected by the customer. Thus, the customers may be enticed to make purchase from local SMB's that are owned or operated by local owners in the customers' neighborhood. Therefore, the system may encourage customers to be heroes in their community for supporting local SMB's.

Accordingly, process 300 allows a customer to search for local merchants near the customer. In particular, local merchants who offer the desired produces or services may be found for the customer. The customer may purchase products/services from local merchants at the online marketplace. The local merchant may be notified of the purchase and deliver or prepare purchase items for pickup by the customer. The local merchant may create customer profiles to provide personalized service to frequent local customers.

The following is an exemplary scenario in which the above processes 200 and 300 may be implemented:

Lisa owns and operates a small flower shop called “Lisa's Floral” in a small town of Springfield. Lisa's Floral does not have a website. As such, Lisa registers Lisa's Floral at an online marketplace for local merchants at eBay Local. A local merchant account is created for Lisa's Floral. The merchant account includes Lisa's Floral's location, operating hours, contact information, and the like. Lisa also designates neighborhoods or zones where delivery service is available for free and neighborhoods or zones where deliver service is available for a fee. Lisa then uploads products/services offered at Lisa's Floral to the online marketplace. The products/services include pictures/videos of various floral arrangements, prices, availability, preparation time, delivery time, and the like.

Amy lives in a neighborhood near Lisa's Floral. Amy is visiting a friend today and wishes to purchase and bring a floral arrangement with her to her friend's place. Amy uses an eBay Local shopping app on her cell phone to look for local merchants who sells floral arrangements. The search returns a list of local floral shops including Lisa's Floral. Amy selects Lisa's Floral because they offer free delivery to Amy's neighborhood. Amy then browses the virtual store of Lisa's Floral at the online marketplace. Amy selects a floral arrangement she likes and proceeds to purchase the floral arrangement at the virtual store. Amy also enters special instructions on the type and color of vase to use and how the floral arrangement is to be packaged. Amy also selects for the floral arrangement to be delivered to her and requests that the delivery be made between 1:00 PM and 2:00 PM.

Lisa receives Amy's request and confirms that the requested floral arrangement is available. Further, Lisa confirms that she is able to fulfill the special instructions on the floral arrangement and the delivery. Amy then pays for the floral arrangement at the online marketplace. Lisa then begins to prepare the floral arrangement based on Amy's special instructions using a certain type and color of vase. Lisa also has the floral arrangement packaged and delivered to Amy at the requested time window. Amy receives the floral arrangement and appreciates the personalized and speedy deliver of the floral arrangement from Lisa's Floral. Amy provides a good rating for Lisa's Floral on the online marketplace. Further, Lisa created a customer profile for Amy. The customer profile includes Amy's name and address, Amy's special instructions, color, style, and floral preferences based on Amy's purchase. Thus, Lisa may remember Amy's personal preferences and may provide personalized service to Amy for Amy's next purchase. Notifications or advertisements also may be generated based on Amy's preferences and sent to Amy.

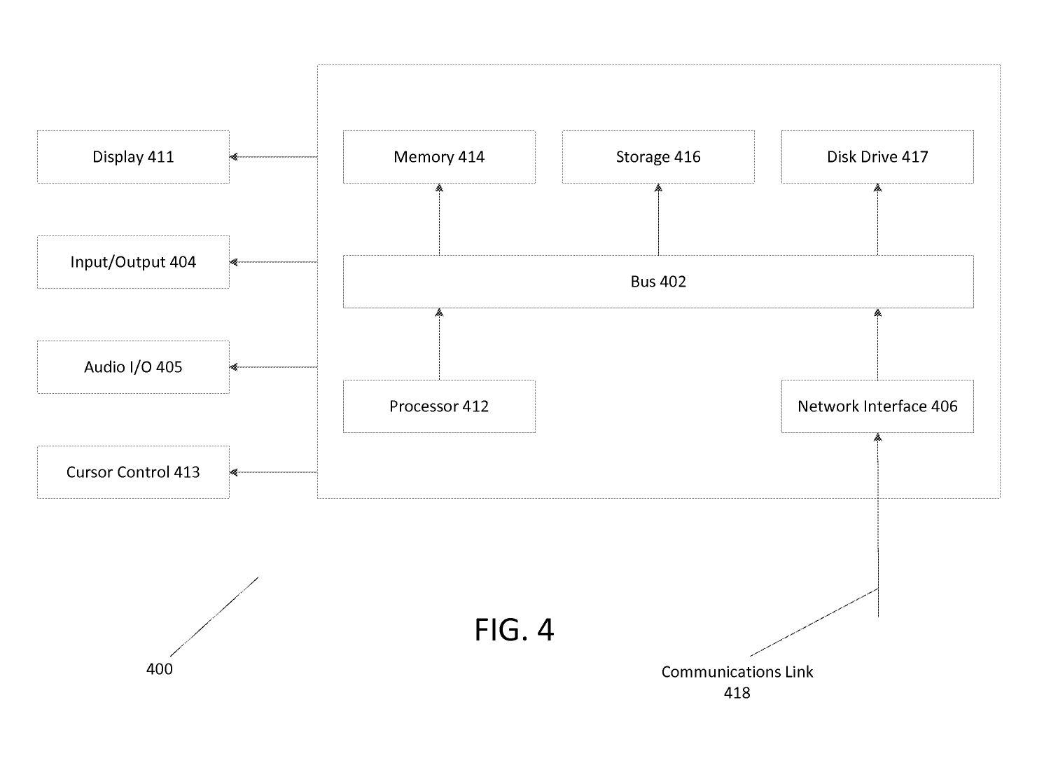

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, wearable computing device, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 160. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure, Thus, the present disclosure is limited only by the claims.

1. A system, comprising:
a non-transitory memory storing account information of local merchants; and
one or more hardware processors coupled to the memory and operable to perform a method comprising:
searching the account information for local merchants located near a user;
determining information about the user based on a location of the user; and
presenting at least one item offered at a local merchant to the user based on the information, wherein the information comprises a length of time the user has been residing near the location.

2. The system of claim 1, wherein the method further comprising:
receiving, from the user, a purchase request to purchase the at least one item at the local merchant;
receiving a confirmation from the local merchant that the at least one item is available and an acceptance from the local merchant accepting special instructions of the user included in the purchase request; and
processing a payment transaction between the user and the local merchant for purchasing the at least one item.

3. The system of claim 1, wherein the local merchants are searched based on availability of products or services requested by the user.

4. The system of claim 1, wherein the local merchants are searched based on service areas of the local merchants that include the location of the user.

5. The system of claim 2, wherein the special instructions include a preferred time of delivery of the user.

6. The system of claim 2, wherein the special instructions include a preferred manner of packaging of the user.

7. The system of claim 1, wherein the method further comprising presenting information to the user regarding local neighborhoods where the local merchant provides delivery service.

8. The system of claim 1, wherein the one or more hardware processors are further operable to perform the method further comprising:
receiving a registration of the local merchant at an online marketplace;
receiving product/service information of the local merchant;
receiving local delivery service settings of the local merchant; and
updating a status and inventory of the local merchant.

9. The system of claim 8, wherein the local delivery service settings define one or more delivery zones where the local merchant provides delivery service.

10. The system of claim 8, wherein the delivery service settings indicate various delivery fees corresponding to various delivery zones.

11. A method comprising:
searching, by a processor of a marketplace server, for local merchants located near a user;
determining, by the processor, information about the user based on a location of the user; and
presenting, by the processor, at least one item offered at a local merchant to the user based on the information, wherein the information comprises a purchase history of the user with local merchants.

12. The method of claim 11 further comprising:
receiving a request from the user for making a purchase at the local merchant;
receiving special instructions from the user regarding the purchase; and
creating a customer profile for the user based on the purchase and the special instructions.

13. The method of claim 11 further comprising:
presenting the at least one item at a virtual store of the local merchant; and
providing an interface for the local merchant to customize the virtual store.

14. The method of claim 11 further comprising:
presenting the at least one item at a virtual store of the local merchant; and
providing a communication tool at the virtual store of the local merchant to facilitate real time communication between the user and the local merchant.

15. The method of claim 11 further comprising:
receiving a registration from the local merchant at an online marketplace;
receiving product/service information of the local merchant;
receiving local delivery service settings of the local merchant; and
updating a status and inventory of the local merchant.

16. The method of claim 15, wherein the delivery service settings indicate various delivery times corresponding to various delivery zones.

17. The method of claim 15, wherein the delivery service settings indicate a routine delivery schedule of the local merchant.

18. A non-transitory computer-readable medium comprising instructions which, in response to execution by a computer system, cause the computer system to perform a method comprising:
searching for local merchants located near a user;
determining information about the user based on a location of the user; and
presenting at least one item offered at a local merchant to the user based on the information, wherein the information comprises a purchase history of the user with local merchants.

19. The non-transitory computer-readable medium of claim 18, wherein the method further comprises receiving a request from the user to purchase the at least one item including special instructions indicating a preferred time of delivery of the user.

20. The non-transitory computer-readable medium of claim 18, wherein the method further comprises receiving a request from the user to purchase the at least one item including special instructions indicating a preferred manner of packaging of the user.

21. The non-transitory computer-readable medium of claim 18, wherein the method further comprises:
receiving a registration from the local merchant at an online marketplace;
receiving product/service information of the local merchant;
receiving local delivery service settings of the local merchant; and
updating a status and inventory of the local merchant.

22. The non-transitory computer-readable medium of claim 21, wherein the delivery service settings indicate a routine delivery schedule of the local merchant.
